(19) United States
(12) Patent Application Publication
(10) Pub. No.: US 2024/0187879 A1
(43) Pub. Date: Jun. 6, 2024

(54) METHOD AND SYSTEM FOR OPTIMIZING A MOBILE COMMUNICATIONS NETWORK

(71) Applicant: Telecom Italia S.p.A., Milano (IT)

(72) Inventors: Simone BIZZARRI, Torino (IT); Giorgio GHINAMO, Torino (IT); Roberta GIANNANTONIO, Torino (IT); Ennio GRASSO, Torino (IT); Giuseppe MINERVA, Torino (IT)

(73) Assignee: Telecom Italia S.p.A., Milano (IT)

(21) Appl. No.: 18/285,300

(22) PCT Filed: Mar. 22, 2022
(86) PCT No.: PCT/EP2022/057441

§ 371 Date: Oct. 2, 2023

(30) Foreign Application Priority Data
Apr. 2, 2021 (IT) 102021000008381

(51) Int. Cl. H04W 24/02; H04W 16/22; H04W 24/06

(52) U.S. Cl. CPC H04W 24/02; H04W 16/22; H04W 24/06

(57) ABSTRACT

A method, implemented by a data processing system, of adjusting modifiable parameters of network cells of a self-organizing cellular mobile communications network, comprising: retrieving a current configuration of network cells currently deployed on field, including modifiable parameters; exploring different configurations of the network cells, each differing from the retrieved current configuration and from other different configurations by a change in the value of at least one of the modifiable parameters of at least one network cell; evaluating the explored different configurations of the network cells.

### TECHNICAL FIELD

The present disclosure relates to the field of mobile communications networks. In particular, the present disclosure relates to the optimization of mobile communications networks. More specifically, the present disclosure is directed to a method of Coverage and Capacity Optimization (CCO) for mobile Self Organizing Networks (SON), and to a system for implementing the method.

### TECHNICAL BACKGROUND

In the field of cellular mobile communications networks (in the following also referred to as “cellular networks” or “mobile networks” or “mobile communications networks”, for the sake of conciseness), “Coverage and Capacity Optimization” (“CCO” in short) has the aim of providing the best configuration for network cells able of maximizing both network coverage and network capacity to mobile network users on the field. This can be achieved with modifications to adjustable, tunable parameters of the network cells. Examples of cells' tunable parameters are transmission power, electrical tilt and azimuth of the antennas, and any other available parameter affecting radiation diagram and power spatial distribution, including but not limiting parameters controlling radiation patterns for active antennas.

“Self Organizing Networks” (“SON” in short) is an automation technology paradigm able to perform the steps of planning and optimization (but also configuration and management) of cellular mobile communications networks, particularly of the fourth generation (“4G”), fifth generation (“5G”)—where the impact of SON algorithms such as the CCO is expected to be particularly significant—and next generations, using a more flexible approach for continuous improvement of performance even in closed-loop configuration.

The SON paradigm aims to make the planning and optimization phases of a cellular mobile network (from the fourth generation onwards) easier and faster. Thanks to SON algorithms such as CCO—operating on cells' tunable parameters such as cell's antenna(s) electrical tilt, cell's transmission power and cell's antenna(s) azimuth, just to mention a few—it is possible to improve the performance, for example in terms of user throughput and/or carried traffic, also through continuous closed-loop optimization.

Belonging to the SON paradigm are also the so-called “self-healing algorithms”, which act when some devices of the mobile communications network go into temporarily fault, and “self-configuration algorithms”, adopted to automatically perform the configuration of new devices added to the network.

Basically, there are two fundamental types of SON: the “Centralized SON” (“C-SON”) which work on large numbers of cells with centralized logic, and the “Distributed SON” (“D-SON”) which, on the other hand, operate at level of the single network node (e.g., single cell) for local optimization purposes.

The CCO problem for a cellular mobile communications network is typically hard. As mentioned above, there are several cell's parameters that may be tuned to improve Coverage and Capacity on fields. Considering, for sake of simplicity, only antennas' electrical tilt configuration (a similar reasoning also applies to other cells' tunable parameters such as power transmission, antenna azimuth or a combination of the above), and focusing on a delimited geographic area where a number (' of network cells can be tuned, each of them with a number T of discretized electrical tilts to that can be selected, the possible solution space is:

|tilts|^{|cells|}=|T|^{|C|}

This constitutes an NP-hard combinatorial optimization problem where the number of admissible configurations grows exponentially with the number C of cells in consideration. For the sake of simplicity, assuming that all the network cells have the same number T=5 of possible electrical tilts (more generally, each network cell might have a different number of permissible electrical tilts):
13 cells with 5 tilts means 5¹³≅1.2 billions of possible configurations, and
16 cells with 5 tilt means 5¹⁶≅152 billions of possible configurations.

Such solution space is prohibitively too large to be systematically explored by any optimization algorithm, and therefore there is the need for a smart and economical approach capable of finding an optimal (or quasi-optimal) solution by only exploring a subset of all solutions in the space.

“Reinforcement Learning” (“RL”) is a discipline of Artificial Intelligence and Machine Learning that studies algorithms for achieving a defined goal that works with continuous interaction with the target environment and receives feedbacks (“rewards”) from it.

US 2013/122885 A1 discloses a parameter setting apparatus that includes a memory, and a processor that executes a procedure in the memory, the procedure including, selecting and executing one of a plurality of optimization operations to optimize a control parameter of a mobile communication network in accordance with a common value function, in response to a state variable in each of a plurality of different areas in the mobile communication network, the common value function determining an action value of each optimization operation responsive to the state variable of the mobile communication network, determining a reward responsive to the state variable in each of the plurality of areas, and performing reinforcement learning to update the common value function in response to the reward determined on each area. A SON application performs Coverage and Capacity Optimization (CCO) to optimize setting of the tilt and azimuth of an antenna of the base station, and transmitting power of the base station. The SON application performs energy saving (ES) to optimize the power on and power off control of a radiowave transmitter of the cell. A model of the reinforcement learning is mentioned, the reinforcement learning being a process of an agent that interactively learns from the environment, and improves a policy to maximize a total amount of finally gained reward. An example of the reinforcement learning is Q-Learning. The reinforcement learning is applied to the learning of a startup process of the SON application by a SON controller. When the reinforcement learning is applied to the SON controller, one state, and one agent are arranged in a system including at least one cell, and the agent selects one of the SON applications as an action. The state is a combination of discretized values of state components. For example, the state components may include cell-edge throughput, cell throughput, cell-edge packet transfer efficiency, cell mean packet transfer efficiency, cell-edge interference level, cell mean interference level, call success rate, lost-call rate, radio resource usage rate, mobile station distribution, energy saving mode, and adjacent cell load. The reward is determined by weighting the reward components and scalarizing the weighted reward components: cell throughput, call success rate, lost-call rate, radio resource usage rate, and load unbalance rate.

Nikolay Dandanov et al, “Dynamic Self-Optimization of the Antenna Tilt for Best Trade-off Between Coverage and Capacity in Mobile Networks”, Wireless Personal Communications volume 92, pages 251-278 (2017) propose a method for capacity and coverage optimization using base station antenna electrical tilt in mobile networks. The solution is based on the application of reinforcement learning. A learning algorithm for automated antenna tilting is developed.

### SUMMARY

In respect of US 2013/122885 A1, the Applicant observes that it proposes a method for CCO in the SON context using a model-free Reinforcement Learning approach, and cannot be applied with accurate network simulators (like those network simulators that simulate the propagation of radio signals through a territory taking into account data describing the territory, like natural orography, presence of human artefacts—buildings and so on—, presence of trees etc., of the type used during the planning phase of a mobile communications network) that, being accurate, are relatively slow, requiring times of the order of minutes to run the simulation of a single network configuration. A model-free RL approach can work with fast, but not accurate, network simulators.

Similar considerations apply to the work of Nikolay Dandanov et al: also in this case, direct (model-free) Reinforcement Learning approaches are proposed which require a very fast (and thus inherently not accurate) network simulator, able to run a simulation of a network configuration in times that are not compatible with the execution times of accurate network simulators of the kind discussed a few lines above.

The Applicant have tackled the problem of devising an improved method and system for CCO in a SON mobile communications network.

According to an aspect of the present disclosure, there is provided a method, implemented by a data processing system, of adjusting modifiable parameters of network cells of a self-organizing cellular mobile communications network.

The method according to the present disclosure comprises:
retrieving a current configuration of network cells currently deployed on field, the current configuration of network cells including, for at least some of the network cells, modifiable parameters;
starting from the retrieved current configuration of the network cells, exploring different configurations of the network cells, each different configuration of the network cells differing from the retrieved current configuration of the network cells and from other different configurations of the network cells by a change in the value of at least one of the modifiable parameters of at least one network cell, and
evaluating the explored different configurations of the network cells.

Exploring different configurations of the network cells comprises iterating the following steps:
building a search tree in which each node of the search tree corresponds to a respective different configuration of the network cells, said building a search tree comprising:
   selecting a path of nodes of the search tree from a search tree root node to a search tree leaf node, wherein the nodes in the path are selected by means of a node selection policy;
   expanding the search tree by identifying at least two new tree child nodes in respect of the search tree leaf node;
   assigning to each new tree child node a respective child node value, wherein said assigning values to the new tree child nodes comprises:
      predicting, by means of a machine learning model, values of network performance indicators corresponding to the different configurations of network cells that corresponds to each of the new tree child nodes, and
      calculating values of a reward function in respect of the predicted values of the network performance indicators;
   selecting, among the new tree child nodes, at least one new tree child node according to a ranking of the calculated values of the new tree child nodes;
   subjecting to simulation by a network simulator the selected at least one new tree child node for obtaining simulated values of the network performance indicators corresponding to the different configuration of network cells that corresponds to the selected at least one new tree child node;
   calculating values of the reward function in respect of the simulated values of the network performance indicators;
   updating a respective node information of the selected at least one new tree child node and of the search tree nodes back along the path from the selected at least one new tree child node to the search tree root node;
   based on the calculated values of the reward function, assessing a goodness of the different configuration of network cells corresponding to the selected at least one new tree child node compared to the configuration of network cells corresponding to the search tree root node, and
when a suitable goodness is assessed for the al least one new tree child node, terminating said iterating and automatically deploying on field a new configuration of network cells by modifying one or more of the modifiable parameters of network cells.

In a preferred embodiment of the present disclosure, said node selection policy is based on an Upper Confidence Bound—UCB—criterion.

Updating a respective node information may comprise updating a node average value and a node visit count, said node average value being calculated by averaging the calculated values of the reward function with the previously calculated reward function values in respect of the node.

In embodiments of the present disclosure, said network performance indicators comprise at least one of the following indicators: number of overtarget cells that are experiencing a traffic load higher than a predetermined threshold traffic load; total cell traffic that exceeds a predetermined overtarget total traffic threshold; throughput guaranteed by the cells, and throughput offered to users of the cellular mobile communications network.

Said reward function can be a linear combination of two or more of said network performance indicators.

Preferably, said network simulator is a simulator of the type used in a planning phase of mobile communications network, configured to simulate propagations of radio signals taking into account a description of the geographic area covered by the network cells.

This type of network simulator is very accurate and the calculated values of the network performance indicators are very reliable.

Advantageously, said exploring and evaluating different configurations of the network cells are performed off-line in background, while the mobile communications network continues operating according to the current configuration of network cells.

In this way, the regular operation of the mobile communications network is not affected while finding a new, optimized network configuration.

In embodiments, said exploring different configurations of the network cells comprises, at each iteration or at least every predetermined number of iterations:
building the search tree by selecting as a new search tree root node one of the new tree child nodes identified in previous iterations and which, based on the calculated values of the reward function in respect of the simulated values of the network performance indicators, has an assessed goodness higher than a goodness of the previous search tree root node selected in previous iterations.

The modifiable parameters of network cells may comprise one or more of: cell transmission power, electrical tilt of the cell antenna(s), azimuth of the cell antenna(s), parameters affecting a radiation diagram and a power spatial distribution. The modifiable parameters of network cells may include parameters controlling radiation patterns for active antennas.

Advantageously, a geographic area of interest covered by the mobile communications network is identified, by classifying network cells covering the geographic area of interest in a first class of cells having modifiable parameters that are modifiable by the self-organizing network, and a second class of cells in the neighbourhood of the cells of the first class and whose parameters are not modifiable.

The machine learning model can comprise a regressor having a loss function selected among: mean squared error, mean absolute error, Huber loss, quantile loss.

According to another aspect of the present disclosure, a data processing system is provided, configured for automatically adjusting modifiable parameters of network cells of a self-organizing cellular mobile communications network, the system comprising a self organizing network module comprising a capacity and coverage optimization module, wherein the capacity and coverage optimization module is configured to execute the method of the previous aspect of the present disclosure.

The method and system disclosed herein are able of finding an optimal (or sub-optimal) solution to the CCO problem just exploring (i.e., simulating by means of an accurate network simulator) few of the very vast number of possible solutions. Thanks to this feature, the method and system here disclosed can therefore be applied to optimize mobile communications networks with a training phase that does not require real-time interactions with the environment (i.e., with the mobile network deployed and operating on the field) or real-time interactions with a very accurate and fast network simulator (accurate network simulators are inherently “slow”), but can achieve its goal even if interacting with an accurate offline simulator.

### BRIEF DESCRIPTION OF THE DRAWINGS

Features and advantages of the solution here disclosed, including those mentioned in the foregoing, will appear more clearly by reading the following detailed description of exemplary and non-limitative embodiments. For a better intelligibility, the following description should be read making reference to the annexed drawings, wherein:

FIG. 1 is a pictorial view of a geographic area of interest covered by cells of a SON mobile network whose parameters are to be tuned for CCO;

FIG. 2 schematically depicts an exemplary cell parameter to be tuned for CCO, particularly the electrical tilt of a cell's antenna;

FIG. 3 is an overview, at the level of logical modules, of a system for CCO according to an embodiment of the solution disclosed herein;

FIG. 4A pictorially shows the operation of a standard Monte Carlo Tree Search algorithm;

FIGS. 4B and 4C pictorially show a detail of two phases of the standard Monte Carlo Tree Search algorithm;

FIG. 5 pictorially shows a Tree Search algorithm according to the solution disclosed herein, and

FIG. 6 is a simplified flowchart of a method according to an embodiment of the present disclosure.

### DETAILED DESCRIPTION OF EXEMPLARY EMBODIMENTS

The disclosure in this document proposes a method and a related system for CCO of a cellular mobile communications network (“mobile network”), particularly a 4G, 5G or future generations mobile communications networks adopting the SON paradigm.

The disclosed method and system can be applied to improve network performance in a geographic area covered by the mobile network.

Advantageously, to address the CCO problem, a specific geographic area 105, covered by the mobile network, where the optimization of the network is needed or desired to be performed, is defined. The geographic area 105 (from now on also referred to as “geographic area of interest”) can be chosen taking into consideration several “Key Performance Indicators” (“KPIs”, that are measures of network performance at the network service level, providing the mobile operator with data indicative of the performance of the mobile network), which the mobile network operator wishes to improve to provide better services to mobile network users. Such KPIs may include, but are not limited to:
the number of “overtarget cells” (number that should be minimized, because overtarget cells are network cells experiencing a high traffic load that causes a reduction in user throughput),
the total cell traffic that exceeds an overtarget threshold, for example set by regulatory standards (that should be minimized for similar reasons),
the throughput guaranteed by the cells (to be maximized in order to improve the interferential conditions and therefore the total capacity of the cell/network)
the throughput offered to mobile users (to be maximized in order to improve the quality of service/quality of experience of the mobile network users).

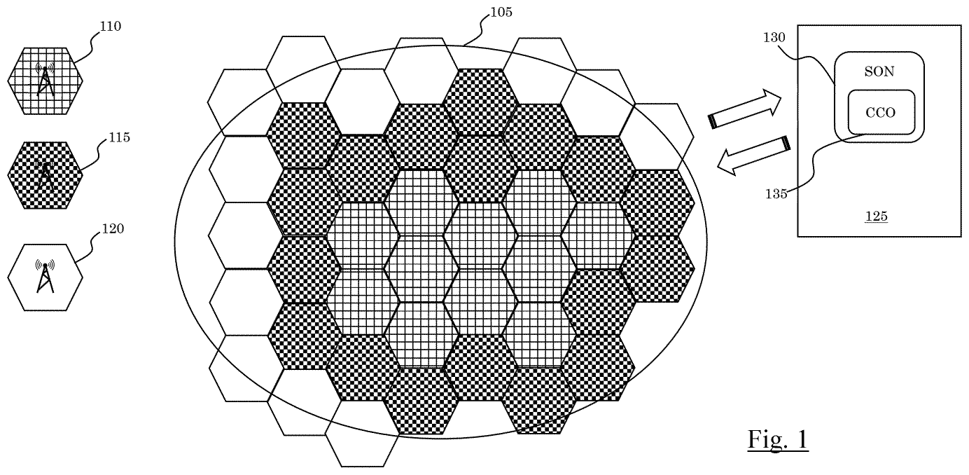

Once the geographic area of interest 105 is defined, the network cells on such area can be conveniently divided into two sets, as schematized in FIG. 1, for the formulation of the CCO problem:
1. a set of “Core cells” 110 to be optimized (by changing—tuning, adjusting—one or more of their configurable parameters, e.g., antenna(s) electrical tilt, antenna(s) azimuth, transmission power);
2. a set of “1^{st} Tier cells” 115, in the neighbourhood of the Core cells 110, that cannot be modified but are nonetheless affected (interfered) by the Core cells 110 and can affect (interfere with) them. Even if the 1^{st} Tier cells 115 do not change their configuration (e.g., antenna(s) electrical tilt) in the course of the optimization, their contribution (in terms of KPIs, as disclosed later on) appears in the optimization function that will be defined for the optimization problem (as discussed later on). The set of the 1^{st} Tier cells 115 includes all the network cells that interfere with and/or are interfered by the Core cells 110.

Preferably, a set of “2^{nd} Tier cells” 120 is also considered, the 2^{nd} Tier cells 120 being cells in the neighbourhood of the 1^{st} Tier cells 115 and that cannot be modified and are not affected by the Core cells 110. The 2^{nd} Tier cells are used to create a boundary for the correct calculations in the network simulator. The 2^{nd} Tier cells are taken into consideration for delimiting a best server area of the 1^{st} Tier cells 115.

Reference numeral 125 denotes a mobile network monitor and configurator system, including a data processing system comprising a SON module 130 and, within the SON module 130, a CCO module 135. The CCO module 135 is a module configured to perform a CCO of the mobile network. The SON module 130 is a module configured to dynamically configure (modify a current configuration deployed on the field) the network cells, particularly based on the results of the optimization performed by the CCO module.

The mobile network optimization procedure is performed by the CCO module 135 on the (cells of the) selected area of interest 105, and is directed to identify a better (“optimized”) configuration of the tunable parameters of the Core cells 110 in the area of interest 105. Once the optimization procedure is completed, the SON module 130 deploys changes of the network configuration on field (modifying the values of the tunable parameters of the Core cells 110, through SON Application Programming Interfaces—“APIs”—that allow remote software configuration of cells' parameters, e.g. antennas' electrical tilts).

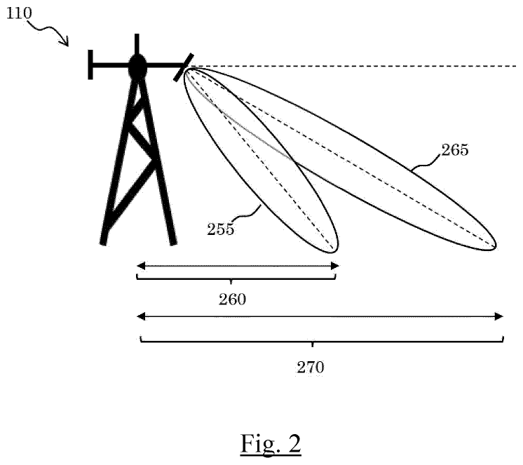

Considering, as an example of configurable parameter of the Core cells 110, the electrical tilts of the Core cells' antennas, FIG. 2 helps to clarify that by changing the tilt of a cell antenna, network performance indicators, such as capacity, coverage and interference, are affected. In particular, a higher tilt 255 reduces the covered area (“service area”) 260, increases the cell capacity dedicated to each user, and reduces the interference; conversely, a lower antenna tilt 265 increases the service area 270, may reduce the capacity dedicated to each user, and can increase the interference.

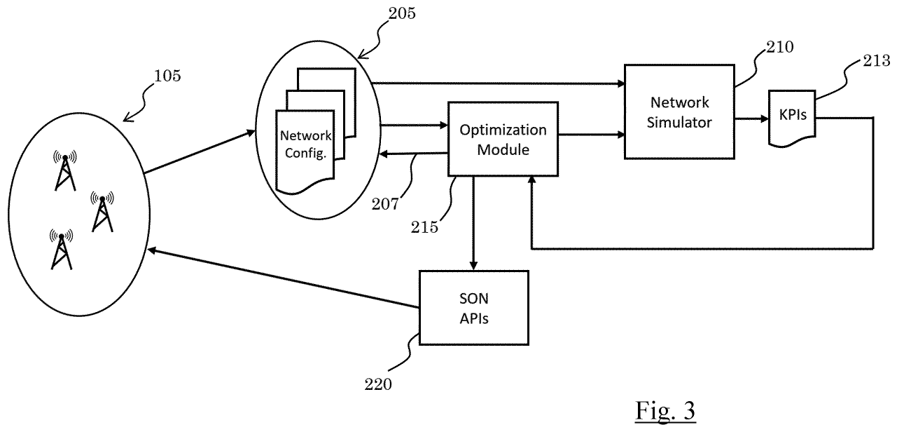

FIG. 3 depicts the logical components of the modules in the network optimization system (CCO module 135).

The logical modules comprise network configurations modules 205, a network simulator module 210, an optimization module 215. Reference numeral 220 denotes SON APIs that allow remote software configuration of cells' parameters (e.g., antennas' electrical tilts) once an optimized configuration is found.

### Network Configurations Modules 205

Since the aim of the optimization is to provide a new mobile network configuration that improves performance for mobile users, a set of parameters that describe a generic network configuration should be defined, so that different network configurations can be tested (by the network simulator 210, configured to run offline with respect to the normal operation of the mobile network, as discussed shortly hereafter) and then, once the best network configuration is found and selected, it is deployed on field (by the SON module 130). Such network configurations will take into consideration values of the parameters coming from the field (e.g., number of average users served by a certain network cell) as well as values of parameters 207 that will be proposed by the optimization module and that refer to cells' settings that can be changed (e.g., antenna tilt).

The set of parameters that are comprised in a generic network configuration can also include parameters that are not under the control of, and thus cannot be optimized by, the SON module 130, such as for example the geographic position of the cells' transceiver stations, the height of the trellises of the cells' antennas, possible losses of the electrical cables, which affect the electromagnetic coverage of the area of interest 105 by the mobile network cells.

Thus, the network configurations modules 205 include a current network configuration, retrieved from the field, i.e., from the cells of the selected area of interest 105, comprising a current configuration of the Core cells 110, of the 1^{st} Tier cells 115 and of the 2^{nd} Tier cells 120.

As the optimization module 215 operates, new network configurations are added to the network configurations modules 205, each new network configuration comprising different values for the tunable parameters of the Core cells 110 (while the parameters of the 1^{st} Tier cells 115 and of the 2^{nd} Tier cells 120 are unchanged, like other parameters that are out of the control of the SON module 130).

Two generic network configurations in the network configurations modules 205 differ from each other in respect of the value of at least one of the tunable parameters of at least one of the Core cells 110. In particular, two generic different network configurations differ from each other in respect of the value of one of the tunable parameters (e.g., antenna electrical tilt, or azimuth, or transmission power) of one of the Core cells 110.

### Network Simulator Module 210

An example of a network simulation tool is described, e.g., in EP1329120B1, in the name of the same Applicant hereto. Since the network optimization problem (CCO problem) to be solved has a huge number of potential candidate solutions to be explored and some solutions are worse than the current network configuration running on field, the optimization process is advantageously run offline (not to impact the operation of the mobile network) and its results are deployed on field, i.e., applied to the Core cells 110 of the area of interest 105 only once the results of the optimization process are proven to improve network performance. For this reason, the network simulator module 210 is configured and employed to calculate the network performance indicators (KPIs 213), which are then aggregated by the optimization module 215 into the optimization function, for different configurations of the network cells as proposed by the algorithm running in the optimization module 215. The network simulator module 210 is configured to take as input network configuration parameters provided by the network configurations modules 205 and to return and submit to the optimization module 215 the KPIs 213 needed for calculating the optimization function of a given network configuration. Network configurations 205 will consider both on-field network KPIs, i.e., values of network performance parameters indicative of the network performance deriving from the network configuration currently deployed on the field, and settings proposed by the optimization module (as schematized by the feedback line 207).

### KPIs for Optimization Function 213

The optimization function F (in the following also referred to as “reward function”) should be analytically formulated so that the CCO algorithm running in the optimization module 215 is able to compare and rank (in terms of “goodness”) the network configurations according to their respective reward values.

The optimization function F can be defined using different network performance indicative parameters or indicators, KPIs 213, as long as they are available from the offline simulations run by the network simulator module 210, so that the CCO algorithm executed by the optimization module 215 has all the data necessary to perform offline optimization and find the best network configuration to be deployed on field.

For example, the optimization function F can be a function of network performance indicators (KPIs 213) such as total network traffic, number of overtarget cells, user average throughput, cell average throughput, albeit other network performance indicators may be taken into consideration as well.

In one embodiment of the present disclosure, the reward function F(c) for the generic configuration c of cells' parameters—e.g., antennas' electrical tilt—to be evaluated strives to maximize a linear combination of the average cell throughput Thr_{cell}(c), the average user throughput Thrᵤₛₑᵣ(c), and at the same time minimize the total cell traffic that exceeds an overtarget threshold OT_{traffic}(c), for example set by regulatory standards. Such maximization objective is constrained such that the total network traffic Traffic(c) of the proposed solution to the CCO problem is greater than or equal to the total network traffic Traffic(reference) in the currently deployed network configuration. In formulas:

[symbol]

(c)=W_{cell}·Thr_{cell}(c)+Wᵤₛₑᵣ·Thrᵤₛₑᵣ(c)−W_{OT}·OT_{traffic}(c)

subject to:

Traffic(c)≥Traffic(reference)

where W_{cell}, Wᵤₛₑᵣ and W_{OT} are weights of the linear combination.

As mentioned in the foregoing, only the KPIs of the Core cells 110 and of the 1^{st} Tier cells 115 enter into the calculation of the reward function F(c).

### Optimization Module 215

The optimization module 215 is configured to execute an optimization algorithm to find the best solution to the CCO problem (i.e., a new configuration of the tunable parameters of the Core cells 110 that improves the network performance).

As described in the foregoing, the CCO is a combinatorial optimization problem. The space of possible configurations grows exponentially with the number of cells and admissible values of cells' tunable parameters, e.g., antennas' electrical tilt ranges, and as such it belongs to the class of NP-hard problems in computer science parlance.

Exact solutions cannot be guaranteed by any tractable optimization algorithm, therefore it becomes paramount to devise an optimization algorithm capable of finding, in a limited allotted time budget, an approximate solution that is sufficiently close to the theoretical optimal.

Optimization algorithms can be ranked according to their ability to find the best approximate solution to an optimization problem with the fewer number of optimization steps, or, equivalently, according to the best found solution given a same number of allotted optimization steps. Such ranking is important since finding a solution to a CCO problem is a highly expensive procedure.

Known approaches to the CCO problem can be divided into two broad categories/classes.

A first category comprises approaches that optimize directly in close loop on real hardware/software of the network cell sites. These methods typically employ some variant of model-free Reinforcement Learning (RL), or “Model Predictive Control” (“MPC”). The Applicant has observed that any approach that is supposed to optimize/learn directly on field is fraught with dangerous and undesirable outcomes. As already mentioned, the optimization/learning process may require many steps, and in this phase the network configurations explored by the optimization algorithm are frequently far from being optimal. As a consequence, the services offered by a mobile network adopting such system would be severely compromised.

A second category of approaches calls for algorithms that are optimized for interacting with a simulator (network simulator) that accurately mimics the real-world scenario. Optimizing/learning with a simulator circumvents the risks/drawbacks of the first category of methods. When the optimization process is complete, the final, best configuration found is deployed on the field with immediate benefits henceforth. Indeed, the found solution will be as advantageous as the accuracy of the simulator. If the simulation carried out by the simulator is not accurate enough, the configuration found by the optimizer will be inadequate in the real deployment, due to the divergent state of affair. However, developing a very accurate simulator is a non-trivial and paramount software endeavour. The simulator needs to have knowledge of the physical propagation of radio signals, interference between sources, absorption by physical obstacles, bouncing and reflection, etc. In addition, the orography of the simulated geographic area needs to be thoroughly represented (not only the natural geography of mounts and valleys, but also all the buildings, streets and artificial/natural structures that influence radio propagation). Such an accurate simulator will have taxing execution costs: even with modern data processing hardware/software, evaluating a single cell configuration might take several seconds. Such performance concerns are the very reason why the optimization algorithm needs to be very efficient in finding the best possible solution in as few optimization steps as possible.

Many prior art documents frame the CCO problem as a Markov Decision Process (MDP) and, in so doing, they tap into the vast knowledge base of RL algorithms. The reason can be that finding an optimal solution (optimal network configuration) for a CCO problem can be thought of as a sequence of actions, each altering a single cell parameter in an ensemble of cell parameters of several cells in a geographic area of interest, all cells (and their parameters) affecting each other in some way. For example, the cell parameters can be the antennas' tilts of a number of cell deployed in a geographic area.

Standard RL algorithms are called “model-free”, in that they learn to directly optimize a reward function without the need for an explicit representation of the state of the world, or “domain knowledge”. Two popular sub-categories of model-free RL algorithms are “Q-learning”, where the objective is to learn the value function of any possible state/action pair, and “Policy Gradient” methods that learn to optimize the best action in any one of the feasible states. Model-free algorithms are very general and can be applied to any problem that can be cast as an MDP problem. Unfortunately, their generality comes at the cost of not being sample-efficient, meaning that they need a conspicuously high number of steps to learn and converge to any meaningful solution. Nowadays, state-of-the-art model-free RL algorithms may require millions of learning steps, and even billions are not unheard of for non-trivial problems.

RL algorithms of another category are called “model-based” in that they exploit the knowledge of the environment (aka the “world” to be optimized, or state of affair). Endowed with such knowledge of the environment, model-based RL algorithms are much more sample-efficient than model-free algorithms. They are called “model-based” because the knowledge of the environment is embedded in a sufficient representation thereof, i.e., a model of the environment. The advantages of the model of the environment come at the cost of making these algorithms less general and more complex since they need an extra component that learns the model besides the policy that decides the best action in a given state.

One extreme of model-based RL algorithms are those algorithms that directly exploit the simulator as their model. They are called “planning algorithms” in that they represent the optimization problem as a planning problem and build a search tree where each node represents a feasible state, and every edge is a valid action that modifies the state leading to its attached neighbour. The root of the search tree is the start configuration, and the leaves of the search tree are all possible configurations reachable from the root. The aim of the planning algorithm is to find a path from the root to (an approximate) optimal leaf in as few steps as possible. As known to those skilled in the art, a leaf node is a node that does not have child nodes that are below it in the search tree, considering the search tree as defined at a given time/stage.

A niche domain that has enjoyed the burgeoning of planning algorithms is the domain of strategic board games, like chess, go, shogi, etc. In these games the domain knowledge is complete and given by the board configurations and game rules. A match playout can be represented as a tree where every node is a board configuration, and an edge is the consequence of performing a valid move on the board. In the past there have been several planning algorithms for playing strategic games, notable mentions being A*, min-max, alpha-beta pruning, etc.

Since late 2000s the “Monte Carlo Tree Search” (“MCTS”) algorithm (first devised in 2006) has become the state-of-the-art gold standard for this type of strategic games (Cameron B. Browne et al., “A Survey of Monte Carlo Tree Search Methods”, IEEE Transactions on Computational Intelligence and AI in Games, Vol. 4, No. 1, March 2012; Michael C. Fu, “Monte Carlo Tree Search: a Tutorial”, Proceedings of the 2018 Winter Simulation Conference, Gothenburg Sweden, ACM). In that context, MCTS is used to solve the “game tree”.

At the core of the MCTS algorithm there is a node selection policy that is based on the concept of “Upper Confidence Bound” (“UCB”) borrowed from the well-established literature of “Multi-Armed Bandit” (“MAB”) problems. MAB problem solutions strike a balance between the exploitation/exploration trade-off of RL algorithms. On the one hand, moves that have produced high rewards should be favoured, thereby exploiting what has been learned thus far. On the other hand, rarely sampled moves should also be favoured because they might lead to promising states and better final rewards. This exploitation/exploration trade-off is exemplified in the following UCB formula that is a mathematical embodiment of the concept “optimism in the face of uncertainty”:

$${UCB}_{t} ( a ) = {argmax}_{a ∈ 𝒜} ( {Q}_{t} ( a ) + c \sqrt{\frac{ln ( {N}_{t} )}{{N}_{t} ( a )}} )$$

where a denotes the generic move and A denotes the set of all possible moves.

The UCB formula ranks all the moves as a linear sum of two terms. The first term is the average value of the move a, Qₜ(a). The second term favours moves that have not been explored enough. The numerator in the square root is the logarithm of the total number of moves thus far, Nₜ, while the denominator Nₜ(a) is the number of times move a has been selected. Moves with a low Nₜ(a) count have a higher UCB score and therefore are ranked higher in the selection of the move.

MAB problems constitute a simplified niche of the broader RL discipline where there is no MDP, in that they lack the concept of state, or, said equivalently, there is only one single state. MCTS extends the concept of UCB to a sequence of states, where each node in the search tree represents a new UCB sub-problem (also referred to as “Upper Confidence for Trees” or “UCT”). In this framework, the value of a move—which determines the value of a node—could indicate the information (being a single value, or a series of values) in a node of the search tree that accounts for the goodness of the overall move from that specific node to the leaf node.

The application of MCTS to games is based on many playouts, also called “roll-outs”. In each playout, the game is played out to the very end of the game by selecting moves at random. The final game result of each playout is then used to weight the nodes in the game tree so that better nodes are more likely to be chosen in future playouts.

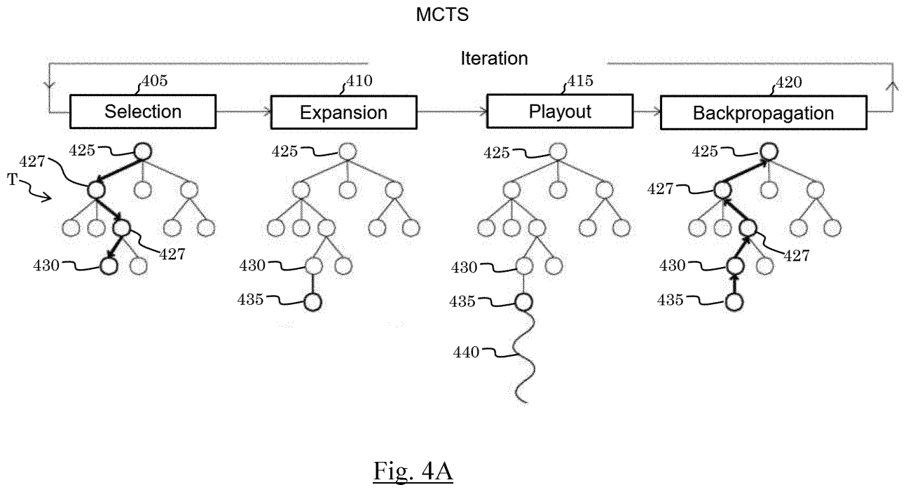

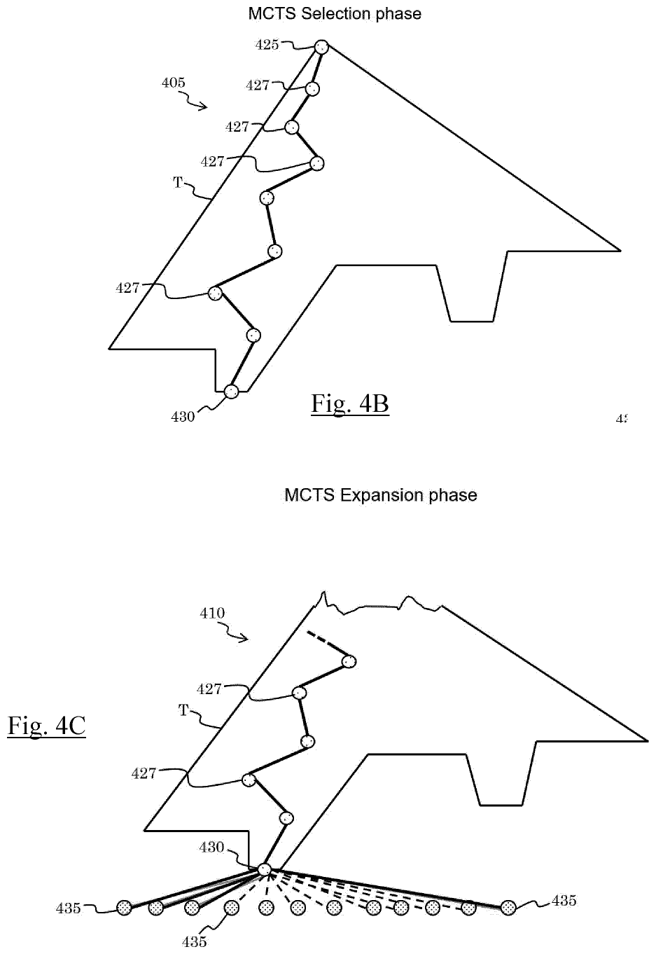

In greater detail, the MCTS algorithm iteratively builds a search tree T until a given computational budget is reached. Four steps are applied per search iteration, as schematized in FIG. 4A:
1. Selection phase 405: starting from the tree root node 425, a path (depicted in bold lines in FIG. 4A) is followed (by recursively applying a node selection policy) through child nodes 427 of the search tree T until a tree leaf node 430 is reached. In this phase each child node 427 below the root node 425 is selected by applying the UCB formula. The Selection phase is schematized in FIG. 4B;
2. Expansion phase 410: the leaf node 430 reached in the Selection phase 405 is expanded by randomly selecting one (or more, usually several, depending on the allowed “moves” from the leaf node 430) new child node(s) 435 to add to the search tree T, according to the valid possible actions in that state (i.e., in the state of the leaf node 430). The Expansion phase 410 of the standard MCTS algorithm is schematized in FIG. 4C;
3. Playout (or Simulation or Rollout) phase 415: a random rollout 440 (choosing random moves out from the allowed moves) from the newly added child node(s) 435 (added during the Expansion phase) is simulated until a terminal state is reached (i.e., a game over state is reached), and
4. Backpropagation phase 420: this is the learning phase of the MCTS algorithm. The value of the terminal state (e.g., in games the value can be a numerical representation of the game outcome: “win” or “loss”—e.g., “+1” or “−1”—reached during the Playout phase 420 is backed up in the path through the visited child nodes 427 (in bold lines in FIG. 4A) to update their statistics, namely their average value Qₜ(a) and visit count Nₜ(a).

The Selection phase 405 is deterministic and completely defined by the UCB formula policy: starting from the root node 425, the child nodes in the path are determined based on the UCB formula. Conversely, the Expansion and Playout phases 410 and 415 are random phases, and are the ones that provide the moniker “Monte Carlo” to the MCTS algorithm.

Since its birth, the MCTS algorithm has become the de facto algorithm for solving strategic board games. Its latest surge into notoriety was brought to media stardom in 2016 by the exploits of DeepMind's AlphaGo and then Alpha-Zero (https://deepmind.com/research/case-studies/alphago-the-story-so-far).

The MCTS algorithm is very sample-efficient and effective in founding optimal moves. Yet these virtues are somehow curbed by being a rather specialized, domain specific algorithm. The MCTS thrives if the problem can be thought of as a strategic board game, where states are game board configurations and actions are moves that alter such configurations.

According to the present disclosure, the Applicant has found that it is advantageous to cast the mobile network CCO problem as a strategic board game, in order to try to apply the MCTS approach to the solution of the CCO problem.

In one exemplary embodiment of the present disclosure, the parameters that specify a mobile network configuration are the electrical tilts of the antennas of the network cells in a geographic area of interest like the area of interest 105 in FIG. 1 (it is pointed out that antennas' electrical tilts are in the following considered, merely for the sake of simplicity, as the only tunable parameter of the network cells, but the present disclosure is not limited to antennas' electrical tilts, being advantageously applicable to additional or different cells' tunable parameters such as azimuth, power transmission and any other available parameter affecting radiation diagram and power spatial distribution, including but not limiting parameters controlling radiation patterns for active antennas).

In the CCO context, a “move” (=single alteration of one configurable parameter of one network cell) of the “game” (=optimal network configuration) is the modification of a single tunable parameter of the network cells, e.g., the electrical tilt of one network cell (referring back to FIG. 1, in the non-limitative example here discussed a “move” is the modification of the antenna electrical tilt of one of the Core cells 110 in the selected area of interest 105, because by definition the Core cells 110 are the set of those cells whose parameters are assumed to be modifiable). Therefore, the valid “moves” at each time step/are the set of all antennas' electrical tilt ranges [symbol] of all Core cells [symbol] :

$${moves}_{t} = {⋃}_{c ∈ 𝒞} {𝒯}_{c}$$

where T_{c} denotes the admissible discrete values that the electrical tilt of the antenna of the generic Core cell c can assume. Due to regulatory or physical restrictions, the cells may not share the same electrical tilt ranges: different Core cells 110 may have different admissible values T_{c}.

The Applicant, in trying to cast the mobile network CCO problem as a strategic board game in order to try to apply the MCTS approach to the solution of the CCO problem, has found that there are however remarkable differences between the former and the latter.

One remarkable difference is that, differently from a strategic board game, in CCO (and other combinatorial optimization problems), there is not a single terminal, final configuration (there is not an end game), because any intermediary configuration represented by a node in the tree is a potential solution to the optimization problem.

Conveniently, the Applicant has devised significant modifications to the standard MCTS approach to substantially improve the performance of the method and system disclosed herein, and has found an optimization algorithm that albeit being inspired by the standard MCTS applied to strategic board games, is different therefrom in many important and noteworthy aspects.

Firstly, since, as mentioned, in CCO there is not a single final configuration that needs to be reached, a more pragmatic pursuit is to find a near optimal solution in as few steps as possible, due to the computational cost of running each simulation of a new proposed candidate network configuration. In fact, in MCTS, the playout in the Playout phase 415 consists of simulating a playout of the game by randomly sampling the “moves” to reach a terminal state, which is the “end of the game”. In CCO there is not a real terminal state (i.e., there is no “end of the game”) because any intermediate node is potentially valid (being a potentially valid configuration for the Core cells 110). The Applicant has perceived that random sampling new configurations for the Core cells 110 and submitting them to the network simulator 210 (for simulating a playout) is a waste of expensive computational resources. This reasoning has led the Applicant to eliminate, in the optimization algorithm according to the present disclosure, the Playout phase 415 of the known MCTS algorithm.

Secondly, the present disclosure envisages the restart of the search tree whenever a new leaf node is found that has a better value of the reward function than the root. According to the present disclosure the algorithm starts a search tree using the best configuration found thus far at the root of the search tree. Then the algorithm proceeds by building the search tree and updating the values of the search tree nodes according to the Selection, Expansion, and Backpropagation phases. According to a preferred embodiment, when the value of (the reward function of) a new child node added to the search tree is higher than the root node's (reward function) value, the search is halted, the search tree is discarded, and a new search tree is started with the newly found best value node at its root. Restarting the search procedure from the best configuration found thus far has the effect of dramatically improving the search by pruning unfruitful search paths.

Thirdly, still according to the present disclosure, to further bolster optimization efficiency the tree search is augmented with a Machine Learning Model (MLM) that is trained on the network configurations that have been sampled and submitted to the network simulator. The MLM learns a model of the network simulator 210 that can be queried in lieu of the network simulator 210 (which, being very accurate is necessarily relatively slow) every time a new network configuration is to be evaluated. Differently from the standard MCTS, the MLM assigns values to the new child nodes added in the Expansion phase, as discussed in detail later on.

The Applicant has found that these differences represent substantial improvements to the standard MCTS approach for applying its logic to the solution of the CCO problem.

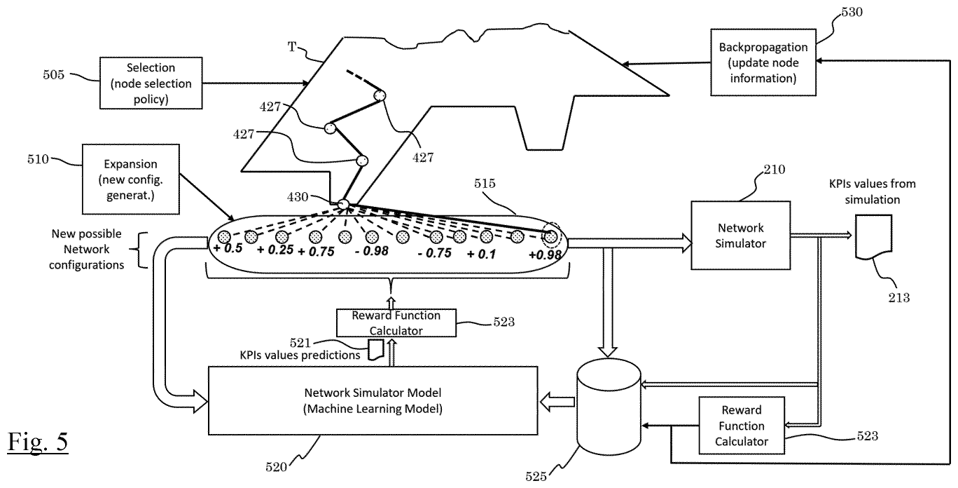

FIG. 5 pictorially shows the structure of a tree search algorithm according to the solution here disclosed.

A Selection phase 505 drives the creation of a path of nodes (starting from a tree root node, not shown in the drawing) through the search tree T, selecting child nodes 427 by applying a node selection policy based on information in the nodes, until a tree leaf node 430 is reached. A preferred node selection policy is the one based on the UCB formula: in this case the information in the nodes, or node value, is represented by the average node value Qt(a) and by the visit count of the node. However, alternative node selection policies based on information in the nodes may be considered, for example the “epsilon greedy policy”, the “Thompson sampling” policy or the “Gittins index” policy. In general, a preferred node selection policy should provide a trade-off between exploitation (i.e., favouring moves that have produced high rewards) and exploration (i.e., favouring rarely sampled moves because they might lead to promising states and better final rewards). In other words, a preferred node selection policy provides for a trade-off between exploitation, favouring nodes (i.e., network configurations) that have produced high rewards (in terms of value of the reward function, as discussed in greater detail later on), and exploration, favouring nodes (i.e., network configurations) rarely explored (because they might lead to promising states and better final rewards).

At the tree leaf node 430, an Expansion phase 510 expands the search tree T by adding to the leaf node 430, if available, one or more new child node/nodes, globally denoted 515, according to all the valid actions in the state of the leaf node 430 (i.e., according to all network configurations obtained by modifying all possible configuration parameters one at a time, and corresponding to the leaf node 430). There is a possibility that the tree leaf node is a terminal node, i.e., no child node exists from the tree leaf node 430, all nodes reachable from tree leaf note 430 being already part of the search tree. In this case, the iteration is considered as completed.

If at least one child node is identified, a MLM module 520, which (as described in greater detail in the following) is a model of the network simulator 210 seen as a black-box function, generates (i.e., predicts) the values of the network performance indicative parameters KPIs of the different network configurations corresponding to the added child nodes 515. While the network simulator 210 is a model of the world that accurately models how the world works, the MLM module 520 does not model the world but rather mimics the operation of the network simulator 210 seen as a black box and predicting outputs in respect of given inputs. The predicted KPIs values generated by the MLM module 520 are approximations of the true values of the KPIs that would be calculated by the network simulator 210 should the latter run real simulations of the corresponding network configurations. The predicted KPIs values are used to estimate a value to each of the added child nodes 515. The estimated values of the added child nodes 515 are calculated by applying (reward function calculator module 523) the reward function F(c) using the predicted KPIs values:

[symbol]

(c)=W_{cell}·Thr_{cell}(c)+Wᵤₛₑᵣ·Thrᵤₛₑᵣ(c)−W_{OT}·OT_{traffic}(c)

subject to:

Traffic(c)≥Traffic(reference)

For example, assuming that the value of the reward function F(c) can range from −1 to +1, the values estimated by the MLM module 520 for the added child nodes 515 can be “−0.98” (“really bad”), “−0.75” (“bad”), “+0.1” (“fair”), “+0.25” (“fairly good”), “+0.5” (“good”), “+0.75” (“very good”) and “+0.98” (“super good”), as depicted in FIG. 5.

Then, (in the next Selection phase of the next iteration) only those added child nodes, among all the added child nodes 515, having high (i.e., most promising) predicted values are selected and submitted to the network simulator 210 for the real simulation of the corresponding network configurations. The network simulator 210 runs the simulation and calculates the corresponding KPIs 213. The simulated KPIs (i.e., the KPIs calculated by simulation) 213, together with the value of the reward function F(c) calculated for them and the corresponding network configurations (reward function calculator module 523), are stored in a database (a data cache) 525 which the MLM module 520 uses for its learning.

The KPIs values 213 calculated by the network simulator 210 are used to calculate (reward function calculator module 523) the value of the reward function F for the simulated network configuration. The calculated value of the reward function F gives an indication of how good that “move” (i.e., that change to the network configuration; in the considered example, the change of the antenna tilt of one of the Core cells 110) is, as a result of the simulation. The calculated value of the reward function F for the simulated network configuration is used in the Backpropagation phase (Backpropagation module 530) to update the values of the nodes in the path from the child node 515 submitted to simulation up to the root node. In particular, in the preferred example using the UCB formula as a node selection policy, for each node 430, 427 in the path from the simulated child node 515 up to the root node the corresponding average value Qₜ(a) is updated averaging the newly calculated value of the reward function F with the previous Qₜ(a) average value, and the visit count of the nodes in the path is increased.

According to the present disclosure, the MLM 520 is a regressor trained to predict the KPIs 213 that could be calculated and outputted by the network simulator 210 given the parameters that constitute a given network configuration. All the network configurations proposed by the tree search algorithm (Selection 505 and Expansion 510) and submitted to simulation by the network simulator 210, along with their respective KPIs value 213 computed by the network simulator 210, are gathered and stored in a data cache (database 525) used to train the MLM. At the very start of the search tree the data cache is empty. Gradually, as new network configurations are proposed and run in the network simulator 210, new data are added to the data cache.

In an embodiment of the solution disclosed herein, the MLM 520 is retrained when a number N of new network configurations are gathered. Choosing N=1 means that the MLM 520 is retrained whenever a single new network configuration is added to the cache. This extreme case may seem wasteful because retraining the model of the network simulator 210 comes at a computational cost. However, this cost is fully compensated by having the MLM 520 as updated and accurate as possible. In any case, nothing prevents from retraining the MLM 520 with a lower frequency.

The data used by the MLM 520 comprises input parameters that describe a certain network configuration submitted to the network simulator 210 and the corresponding KPIs 213 computed and provided in output by the network simulator 210. As mentioned, at the very beginning the dataset in the database 525 is scarce and the accuracy of the trained model may not be very reliable, but as more data (i.e., more simulations of new network configurations found during the tree search and submitted to the network simulator 210) is gathered and stored in the database 525 the MLM 520 will increase the accuracy of its predictions.

The MLM 520 may be implemented in a number of machine learning paradigms, such as “Random Forests”, “Gradient Boosting Machines”, “Gaussian Processes”, “Support Vector Machines”, “Artificial Neural Networks”, etc. Analogously, the loss function (or error function) for the regressor may be any one among known regression losses, such as mean squared error, mean absolute error, Huber loss, quantile loss, etc.

The regression task of the regressor may be framed to predict the reward function, or, advantageously, it may be framed as a multi-output regression task, where the objective is to predict the values of all the various KPIs that appear inside the reward function. This second approach produces more reliable results and is more amenable to adjustments and tuning of the weights that appear in the reward function.

The usefulness of the MLM 520 and its relationship with the search tree will be discussed in greater detail hereafter.

The purpose of the MLM 520 is to estimate, to predict the values of the KPIs 521 of network configurations that have not (yet) been simulated in the network simulator 210. The MLM 520 predicts approximate values of the KPIs 521 for a certain network configuration, KPIs that would be computed and outputted by the network simulator 210 should a real simulation of that network configuration be run. The network simulator 210 requires complex and time-consuming calculations for obtaining the values of the KPIs 213: conveniently, the KPIs values predictions 521 of the MLM 520 are orders of magnitude faster to compute, albeit less accurate.

The Applicant have devised a way to exploit the MLM 520 in symbiosis with the search tree (Selection 505, Expansion 510 and Backpropagation 530). In particular, the Expansion phase 510 in the tree search is augmented with the predictions of the KPIs values 521 made by the MLM 520 (and the corresponding reward function values calculated for the predicted KPIs values 521).

In the Expansion phase 410 of the standard MCTS, the child nodes 435 added to a leaf node 430 of the search tree T have “undefined” values and their visit count is set to zero. This is because these newly added child nodes 435 have not been run in the simulator yet (i.e., no game has yet been played starting from such newly added child node 435). When the next Selection phase 405 reaches these new child nodes 435, they will all produce the same UCB value, and therefore any one of the new child nodes 435 can be picked randomly to break the tie. This means that, in standard MCTS, there is no informed selection of the child nodes 435, any of the added child nodes 435 can be chosen because at this time there is no information that privileges one from the others.

Advantageously, in the algorithm according to the present disclosure, when new child nodes 515 are added to the tree during the Expansion phase 510, rather than initializing their values as “unknown”, they are initialized with the (value of the optimization function/calculated by the reward function calculator module 523 for the) predicted values of the KPIs 521 provided by the MLM 520, and their visit count is set to one. Indeed, these KPIs values predictions 521 cannot be as accurate as the KPIs values 213 calculated by the network simulator 210, but they are nonetheless sufficient to provide a reliable ranking among the values of such newly added child nodes 515. This guarantees a considerable boost when the next Selection phase 505 reaches the same parent node. The values (e.g., the UCB values) of the child nodes 515 will not be the same; rather, the child node 515 with the highest predicted value (like the one encircled in dashed line in FIG. 5) is selected first. The selected child node 515 is then submitted to the network simulator 210 and its value (calculated by applying the reward function calculator 523 to the simulated KPIs values 213) is updated in the Backpropagation phase 530, and conveniently the MLM 520 is retrained with this new piece of data added to its training set.

The presence of the MLM 520 in the loop with the tree search algorithm greatly reduces the number of optimization steps, typically requiring one third of steps compared with the search without MLM (as in standard MCTS).

The algorithm described in the foregoing is a major departure from standard MCTS. In particular, all random (stochastic, “Monte-Carlo”) elements have been suppressed: the Playout phase 415 of the standard MCTS has been removed, and the Expansion phase, that adds new child nodes (that in standard MCTS are selected randomly), has been enhanced with the prediction provided by the MLM, 520, thereby rendering the next selection deterministic and guided by the predicted UCB values. The result is an algorithm that can be called “Model-Based Tree Search”.

Once the optimal configuration has been chosen by the optimization system, it will be deployed on the field thanks to SON APIs that allow remote software configuration of cells' antennas.

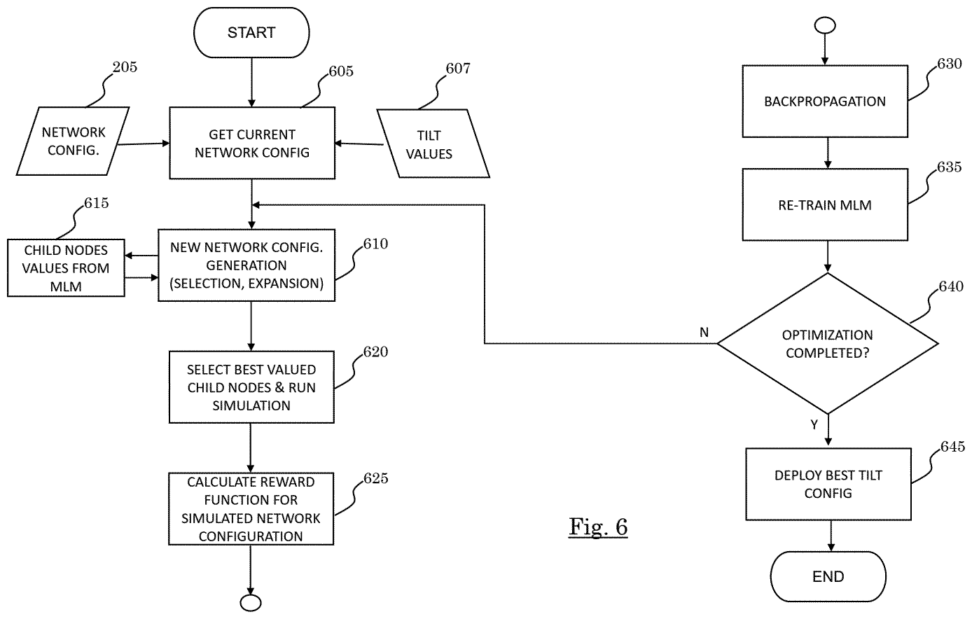

FIG. 6 is a simplified flowchart of a method according to an embodiment of the present disclosure.

Initially, block 605, the CCO module 135 obtains the current network configuration and the admissible values 607 of the Core cells 110 tunable parameters (e.g., electrical tilts of the cells' antennas).

Then, block 610, the Selection phase 505 and the Expansion phase 510 are performed to generate—if available—new network configurations (new child nodes 515). By interacting with the MLM 520 (and the reward function calculator 523), values are attributed to the new child nodes 515 (block 615), the attributed values being based on the predicted KPIs 521 predicted by the MLM 520.

The best valued child node 515 (e.g., the child node shown encircled in dashed line in FIG. 5, having the exemplary predicted value 0.98) is selected and the corresponding new network configuration is submitted to simulation by the network simulator 210 (block 620).

The network simulator 210 runs the simulation and generates simulated KPIs values 213, which are used to calculate the value of the reward function F in respect of the simulated network configurations (block 625).

Block 630 performs the Backpropagation phase 530 to update the average values Qₜ(a) of each visited node and its visit count.

Block 635 retrains the MLM 520 with the newly acquired data generated by the simulator.

Steps 610 through 635 are iterated (decision block 640, exit branch N) until a suitable goodness is assessed for the al least one new tree child nodes, e.g., until the optimization module 215 assesses that no further improvements in the optimization are achieved, or until a predetermined number of iterations has been reached (decision block 640, exit branch Y). For example, the iteration of steps 610 through 635 is terminated when the optimization module 215 assesses that, for a predetermined number of iterations (e.g., ten) no improvements in the value of the reward function are obtained. In an alternative embodiment, the iteration of steps 610 through 635 is terminated after a predetermined number of iterations, the predetermined number of iterations being defined case by case taking into account the specific situation of the self-organizing cellular mobile communications network such as, e.g., the number of cells and the range of values of the cell parameters.

The SON module 130 (SON APIs 220) then deploys the found best configuration on field (block 645).

1. A method, implemented by a data processing system, of adjusting modifiable parameters of network cells of a self-organizing cellular mobile communications network, comprising:
retrieving a current configuration of network cells currently deployed on field, the current configuration of network cells including, for at least some of the network cells, modifiable parameters;
starting from the retrieved current configuration of the network cells, exploring different configurations of the network cells, each different configuration of the network cells differing from the retrieved current configuration of the network cells and from other different configurations of the network cells by a change in the value of at least one of the modifiable parameters of at least one network cell;
evaluating the explored different configurations of the network cells, wherein:
said exploring different configurations of the network cells comprises iterating the following steps:
building a search tree in which each node of the search tree corresponds to a respective different configuration of the network cells, said building a search tree comprising:
selecting a path of nodes of the search tree from a search tree root node to a search tree leaf node, wherein the nodes in the path are selected by means of a node selection policy;
expanding the search tree by identifying if at least one new tree child node in respect of the search tree leaf node is available and, if available, assigning to each new tree child node a respective child node value, wherein said assigning values to the new tree child nodes comprises:
predicting, by means of a machine learning model, values of network performance indicators corresponding to the different configurations of network cells that correspond to each of the new tree child nodes, and
calculating values of a reward function in respect of the predicted values of the network performance indicators;
selecting, among the new tree child nodes, at least one new tree child node according to a ranking of the calculated values of the new tree child nodes;
subjecting to simulation by a network simulator the selected at least one new tree child node for obtaining simulated values of the network performance indicators corresponding to the different configuration of network cells that corresponds to the selected at least one new tree child node;
calculating values of the reward function in respect of the simulated values of the network performance indicators;
updating a respective node information of the selected at least one new tree child node and of the search tree nodes back along the path from the selected at least one new tree child node to the search tree root node;
based on the calculated values of the reward function, assessing a goodness of the different configuration of network cells corresponding to the selected at least one new tree child node compared to the configuration of network cells corresponding to the search tree root node, and
when a suitable goodness is assessed for the al least one new tree child node, terminating said iterating and automatically deploying on field a new configuration of network cells by modifying one or more of the modifiable parameters of network cells.

2. The method of claim 1, wherein said node selection policy is based on an Upper Confidence Bound—UCB—criterion.

3. The method of claim 1, wherein updating a respective node information comprises updating a node average value and a node visit count, said node average value being calculated by averaging the calculated values of the reward function with the previously calculated reward function values in respect of the node.

4. The method of claim 1, wherein said network performance indicators comprise at least one of the following indicators:
number of overtarget cells that are experiencing a traffic load higher than a predetermined threshold traffic load;
total cell traffic that exceeds a predetermined overtarget total traffic threshold;
throughput guaranteed by the cells;
throughput offered to users of the cellular mobile communications network.

5. The method of claim 4, wherein said reward function is a linear combination of two or more of said network performance indicators.

6. The method of claim 1, wherein said network simulator is a simulator of the type used in a planning phase of mobile communications network, configured to simulate propagations of radio signals taking into account a description of the geographic area covered by the network cells.

7. The method of claim 1, wherein said exploring and evaluating different configurations of the network cells are performed off-line in background, while the mobile communications network continues operating according to the current configuration of network cells.

8. The method of claim 1, wherein said exploring different configurations of the network cells comprises, at each iteration or at least every predetermined number of iterations:
building the search tree by selecting as a new search tree root node one of the new tree child nodes identified in previous iterations and which, based on the calculated values of the reward function in respect of the simulated values of the network performance indicators, has an assessed goodness higher than a goodness of the previous search tree root node selected in previous iterations.

9. The method of claim 1, wherein said modifiable parameters of network cells comprise one or more of: cell transmission power, electrical tilt of the cell antenna(s), azimuth of the cell antenna(s), parameters affecting a radiation diagram and a power spatial distribution, and parameters controlling radiation patterns for active antennas.

10. The method of claim 1, comprising identifying a geographic area of interest covered by the mobile communications network, wherein identifying the geographic area of interest comprises classifying network cells covering the geographic area of interest in a first class of cells having modifiable parameters that are modifiable by the self-organizing network, and a second class of cells in the neighbourhood of the cells of the first class and whose parameters are not modifiable.

11. The method of claim 1, wherein said machine learning model comprises a regressor having a loss function selected among: mean squared error, mean absolute error, Huber loss, quantile loss.

12. A data processing system configured for automatically adjusting modifiable parameters of network cells of a self-organizing cellular mobile communications network, the system comprising:
a self organizing network module comprising a capacity and coverage optimization module,
wherein the capacity and coverage optimization module is configured to execute the method of claim 1.
